(19) United States
(12) Patent Application Publication
(10) Pub. No.: US 2026/0246125 A1
(43) Pub. Date: Aug. 20, 2026

(54) COMPACT DUAL-BAND LINEARLY POLARIZED ORTHOMODE TRANSDUCER

(71) Applicant: SWISSto12 SA, Renens (CH)

(72) Inventors: Esteban Menargues Gomez, Préverenges (CH); Detlef Conradin, Lausanne (CH)

(21) Appl. No.: 19/162,366

(22) PCT Filed: Mar. 7, 2024
(86) PCT No.: PCT/IB2024/052216

§ 371 Date: Sep. 4, 2025

(30) Foreign Application Priority Data
Mar. 10, 2023 (FR) FR2302229

(51) Int. Cl. H01P 1/161

(52) U.S. Cl. CPC H01P 1/161

(57) ABSTRACT

A broadband, linearly polarized orthomode transducer can be obtained by additive manufacturing and can comprise: a hybrid coupler comprising: a first waveguide comprising a first input port and a first output port with single polarization; and a second waveguide, comprising a second input port and a second output port with single polarization; and a coupling portion connecting the first waveguide to the second waveguide. The orthomode transducer can further comprise: a septum polarizer comprising: a third input port with single polarization connected to the first output port; and a fourth input port with single polarization connected to the second output port; and a third output port with single polarization; wherein the first and second waveguides are arranged symmetrically with respect to a plane of symmetry containing a septum of the septum polarizer.

However, traditional OMTs generally struggle to be compact while guaranteeing a wide transmission/reception band. On the one hand, there are OMTs such as side-arm OMTs, which are compact but not broadband. In some cases, a side arm can be extended to operate in a second frequency band, but this extension is only possible for one of the two polarizations. On the other hand, there are OMTs, such as “Boifot” junctions or “Turnstile” junctions, which are broadband, but which are not compact since they have an aperture greater than the wavelength λ of a wave having the highest operating frequency of the OMT.

The output ports (101,111) of the hybrid coupler are connected to the septum polarizer 2 via a third input port 200 and a fourth input port 210 of the polarizer, respectively. The other end of the polarizer 2 comprises a third output port 201. The third output port can be connected to a radiating element of the antenna, or even function as a radiating element itself in some embodiments. Each of the polarizer's third and fourth input ports (200, 210) is single-polarized. The polarizer's third output port 201 is dual-polarized.

### TECHNICAL FIELD

The present invention concerns a linearly polarized orthomode transducer which is both compact and dual-band.

### BACKGROUND ART

Orthomode transducers (abbreviated OMT) are passive components widely used in radiofrequency antennas to enable both receive and transmit operation.

Their use is particularly widespread in on-board antennas on communications satellites, so limiting the weight and bulk of such antennas is a crucial issue. The ability of an antenna (and therefore of an OMT) to transmit/receive on several frequency bands is also a determining factor.

However, traditional OMTs generally struggle to be compact while guaranteeing a wide transmission/reception band. On the one hand, there are OMTs such as side-arm OMTs, which are compact but not broadband. In some cases, a side arm can be extended to operate in a second, second frequency band, but this extension is only possible for one of the two polarizations. On the other hand, there are OMTs, such as “Boifot” junctions or “Turnstile” junctions, which are broadband, but which are not compact since they have an aperture greater than the wavelength λ of a wave having the highest operating frequency of the OMT.

EP2330681 A1 describes a single-band orthomode transducer comprising a septum polarizer whose septum allows a 180° phase shift so as to produce 45° polarization.

US2012/0319799A1 describes an orthomode transducer comprising a first septum polarizer connected to a second corrugated polarizer to undo the circular polarization generated by the first polarizer and produce 45° polarization. Broader-band performance is theoretically possible if the transducer length is increased, thus increasing its overall dimensions.

EP2047564B1 describes an orthomode transducer comprising a coupling portion in the form of a lateral arm coupled to the transducer via a slot, allowing 90° rotation of the lateral waveguide. The side arm increases the footprint of the transducer. Furthermore, broadband performance has not been demonstrated for this type of transducer.

### BRIEF SUMMARY OF THE INVENTION

One aim of the present invention is to provide an orthomode transducer free from the limitations of known orthomode transducers.

Another aim of the invention is to provide a broadband orthomode transducer with a reduced footprint.

These aims are achieved by means of the object of the claims and in particular by means of a broadband, linearly polarized orthomode transducer obtained by additive manufacturing comprising:
a hybrid coupler comprising:
   a first waveguide comprising a first input port and a first output port with single polarization; and
   a second waveguide, comprising a second input port and a second output port with single polarization; and
   a coupling portion connecting the first waveguide to the second waveguide; the orthomode transducer further comprising:
a septum polarizer comprising:
   a third input port with single polarization connected to the first output port; and
   a fourth input port with single polarization connected to the second output port; and
   a third output port with single polarization;
      wherein the first and second waveguides are arranged symmetrically with respect to a plane of symmetry containing a septum of the septum polarizer.

The symmetrical arrangement of the coupler's first and second waveguides makes it possible to limit the transducer's footprint, i.e. to achieve a compact cross-section along the entire length of the transducer. This results in a smaller footprint, enabling such devices to be densified in an antenna array, for example.

In a first embodiment, the coupling portion connects a first lateral face of the first waveguide and a second lateral face of the second waveguide, the first and second lateral faces lying in the same plane.

The first lateral face may correspond to a face of the first waveguide of minimum dimension, and the second lateral face corresponds to a face of the second waveguide of minimum dimension.

Advantageously, this configuration further reduces the bulk by arranging the two waveguides of the coupler so that the larger lateral faces of these waveguides face each other. This way, the coupler's footprint is reduced.

In one embodiment, the coupling portion comprises a prism with a trapezoidal base, a first portion of a rectangular face of the prism being in contact with the first lateral face of the first waveguide and a second portion of the rectangular face of the prism being in contact with the second lateral face of the second waveguide.

This geometry of the coupling portion facilitates additive manufacturing of the coupler by limiting cantilevered portions.

The coupling portion can include an impedance-matching element.

In a second embodiment, the coupling portion connects a first lateral face of the first waveguide and a second lateral face of the second waveguide, the first and second lateral faces being arranged in distinct, parallel planes.

This arrangement advantageously reduces the transducer footprint by placing the coupling portion between the two waveguides. Indeed, the outer faces of the coupler, i.e. the faces of one waveguide not directly facing a face of the other waveguide, do not include any protruding element that would increase the transducer footprint.

Advantageously, the coupling portion can comprise a plurality of branches, a first end of each branch being connected to the first waveguide and a second end of each branch being connected to the second waveguide.

In one embodiment, each branch forms a double-sided roof, with a first roof side adjacent to the first lateral face and a second roof side adjacent to the second lateral face. This branch geometry facilitates additive manufacturing by limiting cantilevered portions.

A roof edge formed by the junction of the first and second sides can be contained in a plane perpendicular to a printing direction.

To facilitate additive manufacturing, the first side can form an angle with the first lateral face of the first waveguide of between 35° and 55°, and the second side can form an angle with the second lateral face of the second waveguide of between 35° and 55°.

In order to further limit the cantilever sections of the coupling portion, each branch can form a double double-sided roof comprising a first double-sided roof, of which a first side is adjacent to the first lateral face and a second side is adjacent to the second lateral face, and comprising a second double-sided roof, of which a third side is adjacent to the first lateral face and a fourth side is adjacent to the second lateral face.

The first and third roof sides can advantageously form an angle with the first lateral face of between 35° and 55°, and the second and fourth roof sides can form an angle with the second lateral face of between 35° and 55°.

An edge of the first roof formed by the junction of the first and second sides can form an angle with a printing direction of between 35° and 55°, and an edge of the second roof formed by the junction of the third and fourth sides can form an angle with the printing direction of between 35° and 55°.

### BRIEF DESCRIPTION OF THE FIGURES

Examples of how to implement the invention are shown in the description illustrated by the appended figures in which:

FIG. 1 schematically illustrates an orthomode transducer according to the invention.

FIG. 2 illustrates a septum polarizer.

FIG. 3 illustrates a hybrid coupler with a trapezoidal coupling portion.

FIGS. 4a and 4b illustrate an orthomode transducer comprising the hybrid coupler of FIG. 3.

FIGS. 5a and 5b illustrate a hybrid coupler whose coupling portion comprises a plurality of branches suitable for additive manufacturing.

FIGS. 6a and 6b illustrate a hybrid coupler whose coupling portion comprises a plurality of branches suitable for additive manufacturing.

FIGS. 7a and 7b illustrate an orthomode transducer comprising the hybrid coupler illustrated in FIGS. 6a and 6b.

### EXAMPLE(S) OF EMBODIMENTS OF THE INVENTION

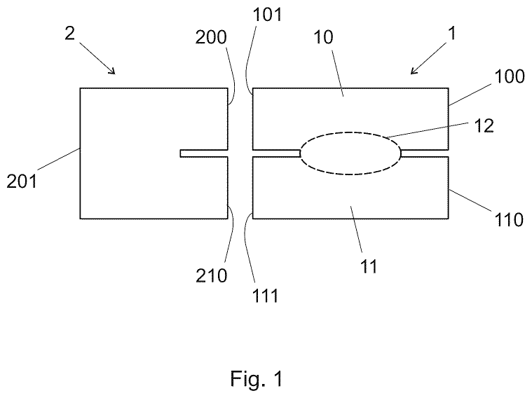

As illustrated in FIG. 1, the orthomode transducer of the present invention comprises a hybrid coupler 1 connected to a septum polarizer 2. The hybrid coupler 1 comprises two waveguides (10,11) arranged in parallel and connected to each other by a coupling portion 12. The septum polarizer 2 is connected to the output ports of the hybrid coupler 1 via two input ports.

When a radiofrequency device including the present orthomode transducer operates in transmit mode, an electromagnetic wave is propagated from the hybrid coupler 1 to the septum polarizer 2, and when it operates in receive mode, from the septum polarizer to the hybrid coupler. The terminology used in the context of the present invention, such as “input port” or “output port”, corresponds to a transmit mode of operation, although the transducer can operate indifferently in transmit and/or receive mode.

The direction of wave propagation in the transducer is therefore parallel to the longitudinal direction of the waveguides of coupler 1 and polarizer 2.

The orthomode transducer of the present invention is obtained by additive manufacturing. The term “additive manufacturing” describes any process for manufacturing parts by adding material, according to computer data stored on a computer medium and defining a model of the part. In addition to stereolithography, the term also refers to other manufacturing methods, such as liquid or powder curing or coagulation, including but not limited to binder jetting, DED (Direct Energy Deposition), EBFF (Electron beam freeform fabrication), FDM (fused deposition modeling), PFF (plastic freeforming), aerosol, BPM (ballistic particle manufacturing), powder bed, SLS (Selective Laser Sintering), ALM (additive Layer Manufacturing), polyjet, EBM (electron beam melting), photopolymerization, etc.

So, although the orthomode transducer comprises two components with different functions, i.e. a hybrid coupler and a septum polarizer, its manufacture requires no assembly after the 3D printing stages. The coupler and polarizer are therefore typically made in one piece.

Hybrid couplers are four-port directional couplers used to separate or combine waves with particular phase relationships. There are two main types of hybrid coupler, one producing a 90° phase shift between the two output ports, the other producing a 180° phase shift between the two output ports. Hybrid couplers also function as power dividers, since the wave generally undergoes 3 dB attenuation, i.e. the waves propagated by each of the output ports have a power equal to 50% of the power of the input wave.

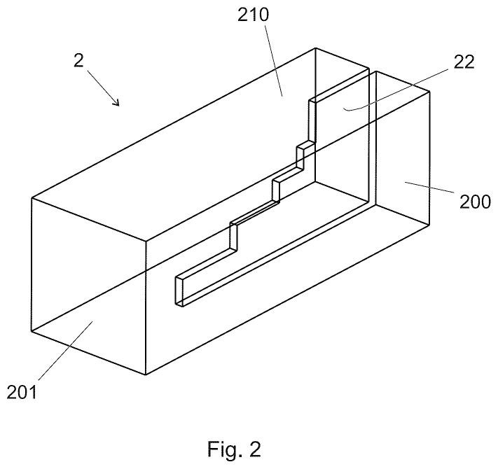

FIG. 2 illustrates a prior art Riblet-type hybrid coupler consisting of two waveguides coupled together via an aperture in the contiguous walls of the two waveguides.

As illustrated schematically in FIG. 1, the first waveguide 10 thus comprises a first input port 100 and a first output port 101, and the second waveguide comprises a second input port 110 and a second output port 111. The phase shift at the output ports depends on the coupling portion 12. Each of these four ports is single-polarized.

The coupling portion 12 of coupler 1 allows a wave propagating in the first waveguide 10 to pass, at least partially, into the second waveguide 11 and a wave propagating in the second waveguide 11 to pass, at least partially, into the first waveguide 10.

Thus, by way of example, a wave propagating through the first input port 100 of the first waveguide 10 will be split between the first and second waveguides (10,11) via the coupling portion 12 and thus exit the hybrid coupler 1 via the first and second output ports (100,101).

The output ports (101,111) of the hybrid coupler are connected to the septum polarizer 2 via a third input port 200 and a fourth input port 210 of the polarizer, respectively. The other end of the polarizer 2 comprises a third output port 201. The third output port can be connected to a radiating element of the antenna, or even function as a radiating element itself in some embodiments. Each of the polarizer's third and fourth input ports (200, 210) is single-polarized. The polarizer's third output port (201) is dual-polarized.

Although the various embodiments shown in the figures illustrate waveguides with rectangular cross-sections, the invention is not limited to these geometries. Indeed, the first and second waveguides (10, 11) as well as the septum polarizer 2 can also have a circular, elliptical, polygonal (regular or irregular), e.g. triangular, pentagonal, hexagonal, octagonal cross-section, and so on.

The hybrid coupler 1 is used to excite the third and fourth input ports of the polarizer 2 simultaneously to create two circular polarizations. The combination of these two circular polarizations by the polarizer septum results in a linear polarization in the third output port 201.

The septum 22 of polarizer 2 is arranged in a plane parallel to the direction of wave propagation in the transducer. The septum is typically of variable height, the highest portion of the septum being disposed at the end of the polarizer comprising the third and fourth input ports (200, 210). The height of the septum can typically decrease linearly or in steps. FIG. 2 shows a polarizer 2 with a stepped-down septum 22.

The orthomode transducer of the present invention can be implemented in different radiofrequency devices intended for various frequency bands depending on their application. The present invention can typically be implemented in devices intended for the following bands: X, Ku, Ka, QV, Ku/Ka, Ka/QV.

Advantageously, the first and second waveguides (10, 11) of the hybrid coupler 1 are arranged symmetrically with respect to a plane of symmetry containing the septum 22 of the polarizer 2.

Advantageously, the cross-section of the septum polarizer 2 measured perpendicular to the direction of wave propagation in the orthomode transducer is the same as the cross-section of the hybrid coupler 1 measured perpendicular to this same direction of propagation. Thus, the diameter of the orthomode transducer (or transducer footprint) measured in a plane perpendicular to the propagation direction is essentially constant along the propagation direction. This feature increases the compactness of the transducer and therefore reduces its footprint, particularly for use in a compact antenna array.

As mentioned above, depending on the coupling portion 12, the hybrid coupler 1 produces a phase shift of 90° or 180°. In transmit mode, this means that an electromagnetic wave propagating through the first or second input port (100,110) of the hybrid coupler will be split into two waves phase-shifted by 90° or 180° relative to each other between the first and second output ports (101,111). Each of the two output waves is also attenuated by −3 dB relative to the input wave. In reception mode, the hybrid coupler receives two waves phase-shifted by 90° or 180° and combines them into a wave whose power is doubled, i.e. increased by 3 dB. Two main embodiments are described below, each corresponding to one of the two phase shifts.

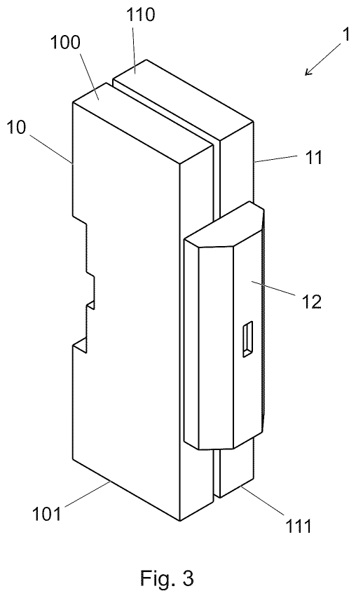

A hybrid coupler 1 according to a first embodiment is illustrated in FIG. 3. The first and second waveguides 10,11 are connected by the coupling portion 12.

On transmit, this coupler splits a wave propagated by the first or second input port (100,110) into two waves 90° out of phase via the coupling portion 12. The two input ports of the septum polarizer 2 are thus each simultaneously excited by one of these two 90°-phase-shifted waves, creating two 90°-phase-shifted circular polarizations.

The two circular polarizations are then combined in the septum polarizer 2, creating in the output port 201 of the septum polarizer a linearly polarized wave inclined at 45° to the input wave of the hybrid coupler 1.

Still according to this first embodiment, the first and second waveguides (10, 11) of the hybrid coupler 1 can have a rectangular cross-section and are arranged parallel to each other, as illustrated in FIG. 3. Advantageously, one of the long sides of the rectangular cross-section of the first waveguide is parallel to one of the long sides of the rectangular cross-section of the second waveguide, so that the larger rectangular lateral walls of the first and second waveguides are arranged in parallel planes.

The two waveguides (10, 11) are connected by a coupling portion 12. More precisely, this coupling portion 12 connects one of the small rectangular lateral walls of the first waveguide 10 with one of the small rectangular lateral walls of the second waveguide 11. The two small rectangular walls lie in the same plane, this plane being perpendicular to the larger rectangular lateral walls of each waveguide. Each of the smaller walls is provided with an opening at the coupling portion so as to allow a wave to pass from the first waveguide to the second or from the second to the first. The coupling portion comprises a waveguide portion extending between these two openings so as to propagate the wave between these two openings.

In a particular embodiment illustrated in FIG. 3, the waveguide portion of the coupling portion 12 has a trapezoidal geometry. More precisely, this waveguide portion comprises a rectangular base contiguous with the smaller side walls of the first and second waveguides (10,11). The waveguide portion extends in a direction perpendicular to the rectangular base, and its cross-section parallel to the base decreases until it forms a rectangular upper face opposite the base, this rectangular face thus having dimensions smaller than those of the base.

The coupling portion 12 can be provided with one or more impedance-matching elements such as ridges, internal protuberances or openings in a wall of the coupling portion. These elements are designed to optimize signal transmission in the coupling portion. As shown in FIG. 3, an opening on the top face of the coupling portion can be arranged to improve signal transmission between the first and second waveguides (10, 11).

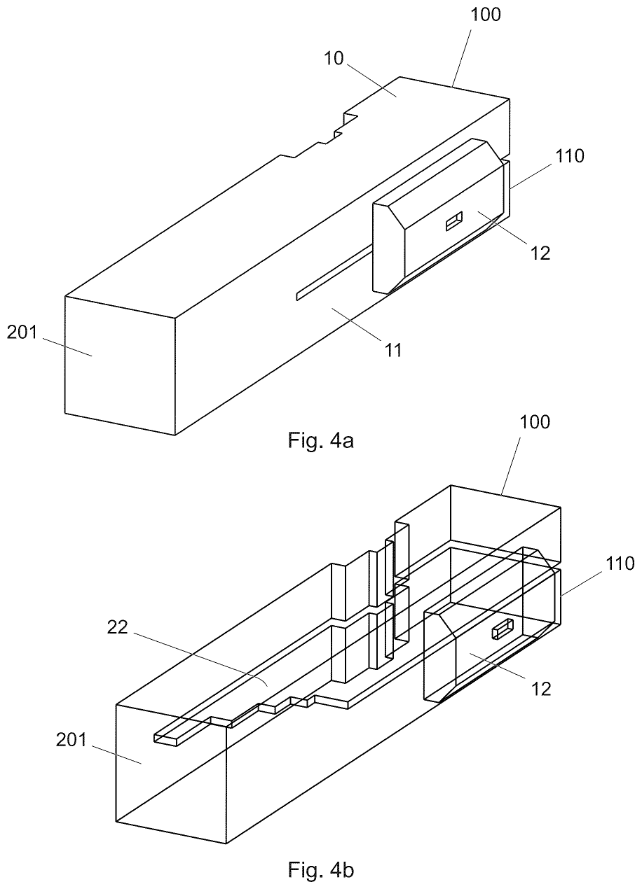

FIGS. 4a and 4b illustrate an orthomode transducer according to the first embodiment described above. The hybrid coupler 1 and the septum polarizer 2 are made in one piece by additive manufacturing, so that no assembly is required to obtain the transducer of the present invention.

In one embodiment, the printing direction of the layers for additive manufacturing coincides with the direction of wave propagation in the orthomode transducer. In order to reduce, or even eliminate, the need for printing supports during manufacture, certain portions of the transducer are adapted for additive manufacturing. In particular, certain cantilevered portions are inclined so as to form an angle significantly less than 90° with the printing direction.

As shown in FIG. 3, the coupling portion 12 of the hybrid coupler may comprise side faces forming an angle of between 35° and 55° with the direction of propagation so as to eliminate the need for any printing supports.

According to a second main embodiment, the orthomode transducer comprises a hybrid coupler 1 producing a 180° phase shift between the two waves output by the coupler when the device is operating in transmit mode.

According to this second main embodiment, the coupling portion 12 of the hybrid coupler 1 connects a first lateral face of the first waveguide 10 and a second lateral face of the second waveguide 11, the first and second lateral faces being arranged in distinct, parallel planes.

In transmit mode, this hybrid coupler 1 splits a wave propagated by the first or second input port (100, 110) into two waves 180° out of phase via the coupling portion 12. The two input ports of the septum polarizer 2 are thus each simultaneously excited by one of these two 180°-phase-shifted waves, creating two 180°-phase-shifted circular polarizations.

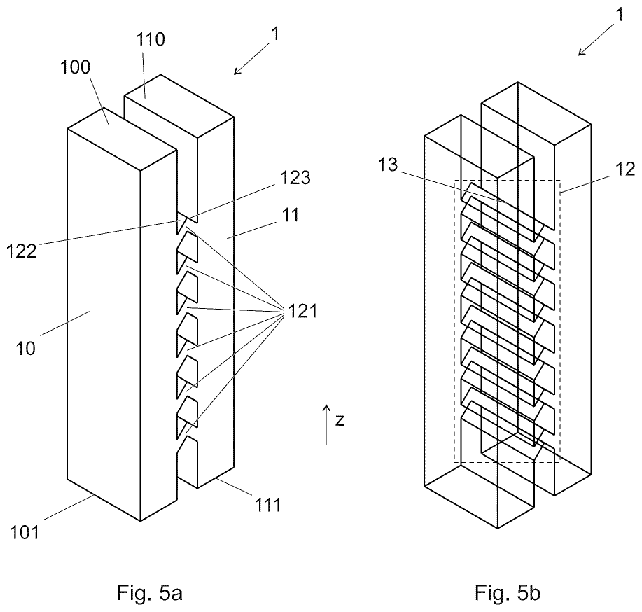

In an embodiment illustrated in FIGS. 5a and 5b, the coupling portion 12 comprises a plurality of branches 121, each branch being connected on the one hand to the first lateral face of the first waveguide 10 and on the other hand to the second lateral face of the second waveguide 11. In this way, each branch 121 intersects the plane of symmetry of the first and second waveguides (10, 11).

Each branch 121 comprises a waveguide for propagating a wave via an opening in the first waveguide 10 to the second waveguide 11 via an opening in the wall of the second lateral face, or vice versa.

In a non-illustrated embodiment, each leg 121 comprises a waveguide extending perpendicular to the side faces of the first and second waveguides (10, 11). The cross-section of this waveguide can be triangular, square, rectangular, pentagonal, hexagonal or, more generally, polygonal. The cross-section of this waveguide may also comprise curved portions in addition to or in place of rectilinear portions.

As before, in order to reduce the need for printing supports, certain portions of the hybrid coupler according to the second main embodiment are inclined with respect to the printing direction. The printing direction is illustrated in FIGS. 5a and 5b by the z axis and corresponds to the direction of propagation of a signal in the coupler.

In particular, the branches 121 can have inclined portions to limit cantilever sections and thus facilitate, or even make possible, additive manufacturing of the device.

In an embodiment illustrated in FIGS. 5a and 5b, each branch 121 advantageously forms a two-sided roof, each of the sides being adjacent to one or other of the first and second waveguides (10, 11). The edge of the roof formed by the junction of the two sides is typically contained in a plane perpendicular to the printing direction z.

The inclination of the two sides can be such that the roof edge points in the direction of the septum polarizer 2 or in the direction of the first and second input ports (100,110). In other words, the double-sided roof has a V-shaped profile pointing in either direction along the z-print axis. Such a geometry of the 121 branches advantageously reduces cantilevered portions and thus facilitates their additive manufacturing, notably by eliminating the need for printing supports.

Each branch forms an angle with the lateral face of the waveguide to which it is adjacent of between 35° and 55°, preferably between 40° and 50°.

In one embodiment, the branches 121 are symmetrical with respect to the plane of symmetry of the first and second waveguides (10, 11). In other words, each roof side is symmetrical to the other with respect to the plane of symmetry of the first and second waveguides.

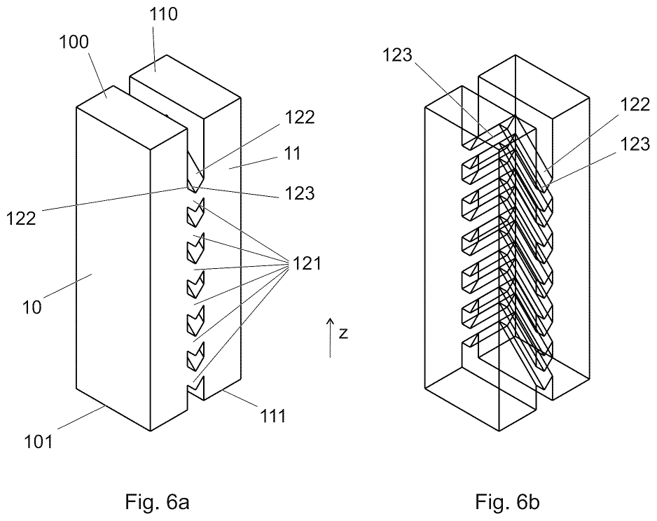

In an embodiment illustrated in FIGS. 6a and 6b, each branch 121 advantageously forms a double double-sided roof. More precisely, each branch 121 comprises a first double-sided roof, each side of which is adjacent to the first or second waveguide (10, 11), and a second double-sided roof, each side of which is adjacent to the first or second waveguide (10, 11). The first and second double-sided roofs are connected to each other in such a way that the edge of the first roof and the edge of the second roof are contained in the same plane. The edge of the first roof forms an angle with the edge of the second roof at the point of connection between the two roofs.

In other words, the embodiment shown in FIGS. 6a and 6b is similar to that shown in FIGS. 5a and 5b, with the difference that each branch of the coupling portion forms a bend in the plane containing the branch edges.

Each of the two edges forms an angle with the printing direction of between 35° and 55°, so that the angle between the two edges is between 70° and 110°.

In one embodiment, each branch 121 has a double symmetry. Indeed, each branch has a first symmetry with respect to the plane of symmetry of the first and second waveguides (10, 11) and a second symmetry with respect to the plane perpendicular to the plane of symmetry of the first and second waveguides containing the printing direction z.

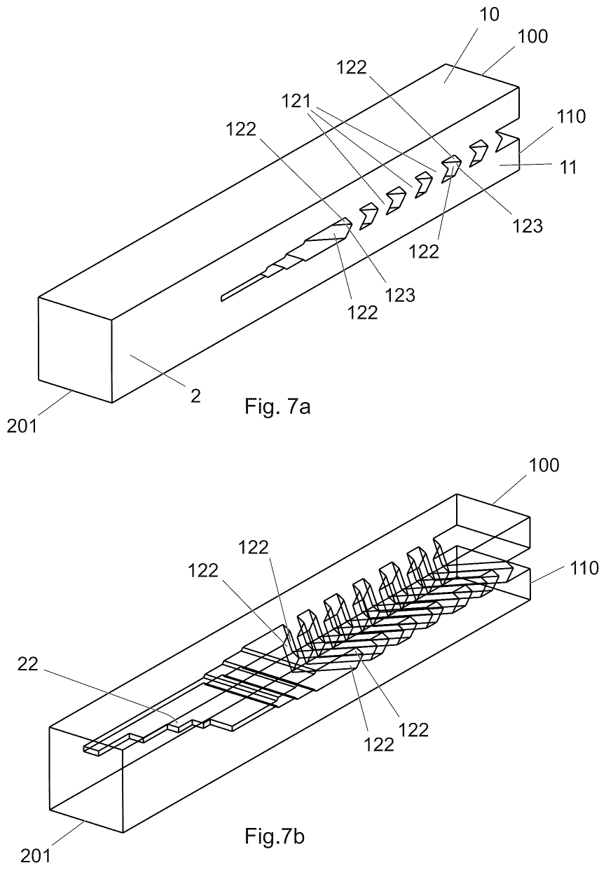

As illustrated in FIGS. 7a and 7b, the orthomode transducer comprising the branch coupler has overall symmetry along a plane containing the septum 22.

### REFERENCE NUMERALS USED ON FIGURES

1 Hybrid coupler
10 First waveguide
11 Second waveguide
100 First input port
101 First output port
110 Second input port
111 Second output port
12 Coupling portion
121 Branch
122 Side
123 Edge
2 Septum polarizer
200 Third input port
210 Fourth input port
201 Third output port
22 Septum
z Printing direction

1. A broadband, linearly polarized orthomode transducer obtained by additive manufacturing comprising:
a hybrid coupler comprising:
a first waveguide comprising a first input port and a first output port with single polarization; and
a second waveguide comprising a second input port and a second output port with single polarization; and
a coupling portion connecting the first waveguide to the second waveguide the orthomode transducer further comprising:
a septum polarizer comprising:
a third input port with single polarization connected to the first output port; and
a fourth input port with single polarization connected to the second output port; and
a third output port with dual polarization;
wherein the first and second waveguides are arranged symmetrically with respect to a plane of symmetry containing a septum of the septum polarizer.

2. An orthomode transducer according to claim 1, wherein the coupling portion connects a first lateral face of the first waveguide and a second lateral face of the second waveguide, the first and second lateral faces being arranged in the same plane.

3. An orthomode transducer according to claim 2, wherein the first lateral face corresponds to a face of the first waveguide of minimum dimension, and the second lateral face corresponds to a face of the second waveguide of minimum dimension.

4. An orthomode transducer according to claim 3, wherein the coupling portion comprises a trapezoidal-based prism, a first portion of a rectangular face of the prism being in contact with the first lateral face of the first waveguide and a second portion of the rectangular face of the prism being in contact with the second lateral face of the second waveguide.

5. An orthomode transducer according to claim 4, the coupling portion comprising an impedance-matching element.

6. An orthomode transducer as claimed in claim 1, wherein the coupling portion connects a first lateral face of the first waveguide and a second lateral face of the second waveguide the first and second lateral faces being disposed in distinct and parallel planes.

7. An orthomode transducer according to claim 6, wherein the coupling portion comprises a plurality of branches, a first end of each branch being connected to the first waveguide, and a second end of each branch being connected to the second waveguide.

8. An orthomode transducer according to claim 7, wherein each branch forms a double-sided roof, a first roof side being adjacent to the first lateral face and a second roof side being adjacent to the second lateral face.

9. An orthomode transducer according to claim 8, wherein an edge of the roof formed by the junction of the first and second sides is contained in a plane perpendicular to a printing direction.

10. An orthomode transducer according to claim 8, wherein the first side forms an angle with the first lateral face of the first waveguide of between 35° and 55° and wherein the second side forms an angle with the second lateral face of the second waveguide of between 35° and 55°.

11. An orthomode transducer according to claim 7, wherein each branch forms a double double-sided roof comprising a first double-sided roof of which a first side is adjacent to the first lateral face and a second side is adjacent to the second lateral face, and comprising a second double-sided roof of which a third side is adjacent to the first lateral face and a fourth side is adjacent to the second lateral face.

12. An orthomode transducer according to claim 11, wherein the first and third sides form an angle with the first lateral face of between 35° and 55° and wherein the second and fourth sides form an angle with the second lateral face of between 35° and 55°.

13. Orthomode transducer according to claim 11, wherein an edge of the first roof formed by the junction of the first and second side forms an angle with a printing direction of between 35° and 55° and wherein an edge of the second roof formed by the junction of the third and fourth sides forms an angle with the printing direction of between 35°and 55°.
